(19) United States
(12) Patent Application Publication
(10) Pub. No.: US 2016/0288152 A1
(43) Pub. Date: Oct. 6, 2016

(54) METHOD AND APPLICATION DEVICE FOR THE APPLICATION OF AN AQUEOUS TREATMENT SOLUTION TO THE SURFACE OF A MOVING STRIP

(71) Applicants: THYSSENKRUPP RASSELSTEIN GMBH, Andernach (DE); ThyssenKrupp AG, Essen (DE)

(72) Inventors: Michael WILD, Neuwied (DE); Paul MICHELS, Arzbach (DE)

(21) Appl. No.: 15/015,255

(22) Filed: Feb. 4, 2016

(30) Foreign Application Priority Data
Mar. 31, 2015 (DE) 10 2015 104 974.0

(51) Int. Cl. B05C 1/08; B05D 7/14; C23C 26/00

(52) U.S. Cl. CPC B05C 1/0813; C23C 26/00; B05D 7/14

(57) ABSTRACT

A method for the application of an aqueous treatment solution to the surface of a strip which is moving at a preset trip speed, includes the following steps: spraying the aqueous treatment solution onto at least one rotating roll of a roll coater with a rotary sprayer having spray rotors disposed side by side in the longitudinal direction of the roll, to which the aqueous treatment solution is supplied and which are made to rotate by a spray rotor drive so that the treatment solution, driven by the centrifugal force, is sprayed in the form of a spray jet onto the surface of the roll; and applying the aqueous treatment solution to at least one surface of the strip by moving the strip past a rotating application roll of the roll coater, with the application roll transferring the aqueous treatment solution in the form of a wet film onto the surface of the strip. Additionally, related to the method, there are an application device having a roll coater and a rotary sprayer as well as to a system for carrying out the method.

### FIELD OF THE INVENTION

The present invention relates to a method for the application of an aqueous treatment solution to the surface of a strip, in particular a steel strip, which moves at a preset strip speed. In addition, the present invention also relates to an application device for the application of an aqueous treatment solution to the surface of a strip as well as to a system for carrying out the method which comprises such an application device.

### BACKGROUND

It is known from the prior art that an optionally coated surface of a steel metal sheet can be treated with an aqueous treatment solution so as to render the steel metal sheet resistant to oxidation and to lower the coefficient of friction to ensure that the steel metal sheet can be more easily processed and shaped during a subsequent processing step, for example, during the production of packaging containers. The publications DE 10 2005 045 034 A1 and DE 10 2012 102 082 B3, for example, disclose methods for passivating the surface of metal-coated steel strips in which an aqueous solution of a treatment agent is sprayed onto a steel strip which moves at a certain strip speed.

An alternative to spraying an aqueous treatment solution to the surface of the strip is the application of the treatment agent by means of a dipping method. In order to ensure a homogeneous distribution of the treatment agent across the entire surface area of the strip, it is necessary, both when using the prior-art spray methods and when using the dipping methods, to apply the aqueous solution in excess of the amount required to the surface of the strip and to remove the excess portion of the treatment solution, for example, by means of squeeze rollers. As a result, both the conventional spray methods and the dipping methods have the disadvantage that relatively large amounts of the aqueous treatment solution are required and that an excess portion of the treatment solution, which is removed from the surface of the strip, for example, by means of squeeze rollers, must be collected in receiving tanks and transported to a recycling station. In addition, the prior-art spray and dipping methods frequently lead to an inhomogeneous application of the aqueous treatment solution to the surface of the strip. This is especially the case when the strip is moved at a high strip speed, for example, of more than 400 m/min through a dipping bath containing the treatment solution or when an aqueous treatment solution is applied by spraying it onto a strip which is moved at such strip speeds.

To avoid these drawbacks, DE 10 2013 107 505 A1 proposes a method for the application of an aqueous treatment solution to the surface of a steel strip which moves at a strip speed of 200 to 700 m/min, in which, after the steel strip has been dried with a gas stream, the aqueous treatment solution is applied to at least one surface of the steel strip by means of a rotary sprayer, said rotary sprayer having a plurality of spray rotors disposed side by side at a right angle to the travel direction of the strip, to which the aqueous treatment solution is supplied and which are made to rotate by a drive so that the treatment solution, driven by the centrifugal force, is sprayed in the form of a spray jet onto the surface of the steel strip, thereby coating said surface with a wet film of the aqueous treatment solution. The wet film of the aqueous treatment solution which has been applied by means of the rotary sprayer is then homogeneously distributed on the surface by means of driven smoothing rollers and is subsequently dried. However, when spraying the aqueous treatment solution by means of a rotary sprayer, it was found that, because of the droplet-like application, it is possible for inhomogeneities to form on the surface of the steel strip, which, after the sprayed-on wet film has dried, create a spot-like appearance.

### SUMMARY

Taking this as a starting point, the problem to be addressed by at least some embodiments of the present invention is to devise a method for the application of an aqueous treatment solution to the surface of a moving strip, by means of which the most homogeneous possible distribution of the treatment solution on the surface of the strip is made possible, without risking the development of spot-like appearance on the surface of the strip after the treatment solution has dried. In addition, another problem to be addressed by at least some embodiments of the present invention is to create a system for carrying out the method, by means of which an aqueous treatment solution can be applied as efficiently as possible and with little waste to the surface of a moving steel strip while ensuring the most homogeneous distribution.

These problems are addressed by means of a method with the features as disclosed herein, with an application device with the features as disclosed herein, and with a system for carrying out the method with the features as disclosed herein. Preferred embodiments of the method and of the devices according to this invention are also disclosed.

In the method according to the present invention, using a rotary sprayer, an aqueous treatment solution is first sprayed onto at least one rotating roll of a roll coater, said rotary sprayer having a plurality of spray rotors disposed side by side in the longitudinal direction of the roll, to which the aqueous treatment solution is supplied and which are made to rotate by a spray rotor drive so that the treatment solution, driven by the centrifugal force, is sprayed in the form of a spray jet onto the surface of the roll. The aqueous treatment solution is subsequently applied to at least one surface of the strip which moves at a preset strip speed, by moving the strip past a rotating application roll of the roll coater, with the application roll transferring the aqueous treatment solution in the form of a wet film to the surface of the strip.

In a first embodiment of the present invention, the rotating roll of the roll coater, onto which the treatment solution is first sprayed by means of the rotary sprayer, can be the application roll itself. However, in an alternative embodiment of the invention, the rotating roll, onto which the treatment solution is sprayed by means of the rotary sprayer, can also be a transfer roll which, relative to the application roll of the roll coater, is disposed in such a manner that their axes run parallel to each other and their surfaces are in contact with each other. In this embodiment of the present invention, the aqueous treatment solution is first sprayed by means of the rotary sprayer onto the rotating transfer roll and transferred by this transfer roll to the application roll in rolling contact with said transfer roll. The application roll applies the aqueous treatment solution to at least one surface of the strip by moving the strip at the strip speed past the rotating application roll. In the process, the transfer roll and the application roll rotate in opposite directions to each other and preferably at the same or at least approximately the same tangential speed.

In both embodiments of the present invention, the surface of the application roll in a transfer zone is in contact with the surface of the strip, with the direction of the tangential speed of the surface of the rotating application roll in this transfer zone corresponding to the travel direction of the strip which is (linearly) moving at the strip speed.

As a rule, the strip speed is greater than 200 m/min and corresponds, for example, to the strip speed at which the steel strips in strip coating lines (such as strip tinning lines) are moved and which typically is in a range between 200 and 700 m/min. The value of the tangential speed of the rotating application roll corresponds substantially to at least the value of the strip speed. This allows an efficient transfer of the aqueous treatment solution from the surface of the application roll to a surface of the strip, without the possibility of friction or slippage developing between the moving strip and the rotating application roll.

Prior to applying the aqueous treatment solution, it is advisable to dry the strip with a gas stream before the strip comes into contact with the surface of the rotating application roll in the transfer zone. Drying the strip preferably takes place by means of an “air knife” which blows a laminar stream of hot air onto the surface of the moving strip.

To coat the surface of the strip as homogeneously as possible with the treatment solution, it may be useful to homogeneously distribute the wet film of the aqueous treatment solution, which has been applied to the surface of the strip by means of the rotary sprayer, using driven smoothing rollers. To this end, driven rotating smoothing rollers are disposed in the travel direction of the strip downstream of the transfer zone. Either immediately after application of the aqueous treatment solution to the surface of the strip by means of the application roll or after homogeneously distributing the wet film, which has been applied by means of the application roll, using the smoothing rollers, the wet film of the treatment solution is dried so as to obtain a dry film coating. Drying can take place in a furnace or by exposing the treatment solution-coated surface of the strip to infrared radiation.

To apply a wet film coating to the surface of the strip as efficiently as possible, the amount of the aqueous treatment solution supplied per unit of time to the spray rotors can be adjusted to the speed of the strip. As a result of such an adjustment, only the amount of aqueous treatment solution actually required to produce a desired dry film thickness of the treatment solution is applied by means of the spray rotors to the rotating rolls of the roll coater (possibly directly to the application roll) to the application roll nd from the application roll to the surface of the strip that is to be treated. In addition, this measure also makes it possible to change the strip speed during operation of the system without applying an excessively high or excessively low amount of the treatment solution to the application roll of the roll coater. In this manner, it is possible, on the one hand, to maintain a desired dry film thickness of the treatment solution and, on the other hand, to avoid the build-up of excess treatment solution on the surface of the strip.

To supply the rotary sprayer with the required amount of aqueous treatment solution, it is useful to link the rotary sprayers to a supply system which comprises a supply line which is connected to the spray rotors of the rotary sprayers, on the one hand, and to a storage tank for the treatment solution, on the other hand. The supply system is preferably automatically controllable via a control system, with the control system also controlling the strip speed of the strip and adjusting the amount of the treatment solution, which is supplied per unit of time to the spray rotors, to the strip speed.

### BRIEF DESCRIPTION OF THE DRAWINGS

These and other features and advantages of the method disclosed by the present invention and of the devices according to the present invention follow from the practical example described in greater detail below with reference to the accompanying drawings. The drawings include:

FIG. 1: A schematic representation of a first practical example of a system for carrying out the method disclosed by the present invention;

FIG. 2: A detail view of a section of the system shown in FIG. 1 in the area of the rotary sprayer and the application roll of the roll coater;

FIG. 3: A lateral view of a second embodiment of a system for carrying out the method disclosed by the present invention, which comprises a first application device according to the present invention on one side of the strip to be treated and a second application device according to the present invention on the other side of the strip.

### DETAILED DESCRIPTION

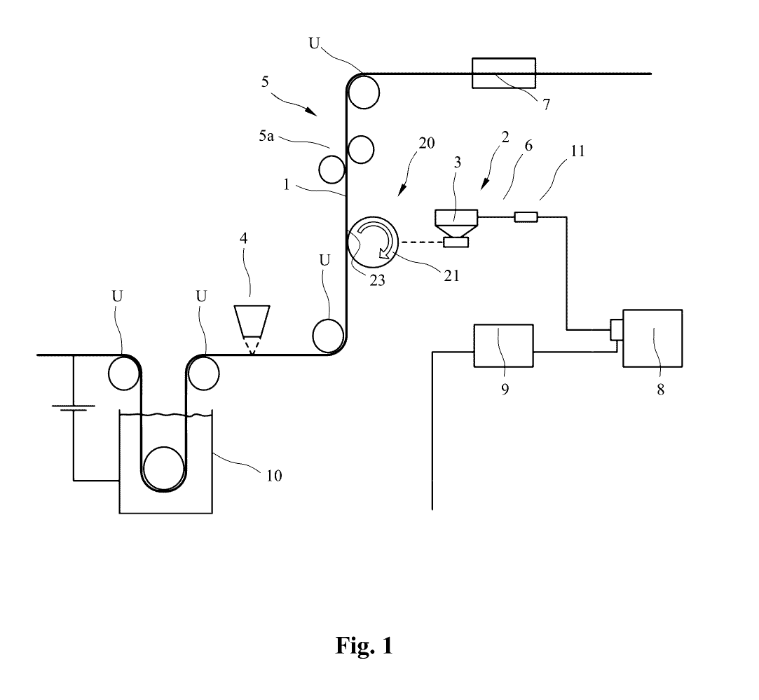

FIG. 1 is a schematic representation of a system for carrying out the method disclosed by the present invention for applying an aqueous treatment solution to the surface of a moving strip in the form of a steel strip. The steel strip 1 is guided over a plurality of deflection rollers U and moves at a preset strip speed v into the travel direction of the strip which in FIG. 1 is designated by an arrow. As a rule, the strip speed is greater than 200 m/min and can be as high as 750 m/min. The steel strip 1 can be a cold-rolled steel strip which is coated with a metal coating, for example, a tinned sheet iron strip or a galvanized steel strip. However, it can also be an uncoated steel sheet strip, for example, a black sheet iron strip.

The steel strip 1 is moved by a transporting system (not shown) at a preset strip speed v in the travel direction of the strip and in the course of this process is guided over deflection rollers U. First, the steel strip 1 is passed through a first drying unit 4 where the surfaces of the steel strip 1 are dried and cleaned. The first drying unit 4 can be, for example, an “air knife” which blows a laminar stream of hot air onto the surfaces of the steel strip 1 moving at the strip speed v in order to dry the surfaces of the steel strip and to blow off undesirable foreign particles.

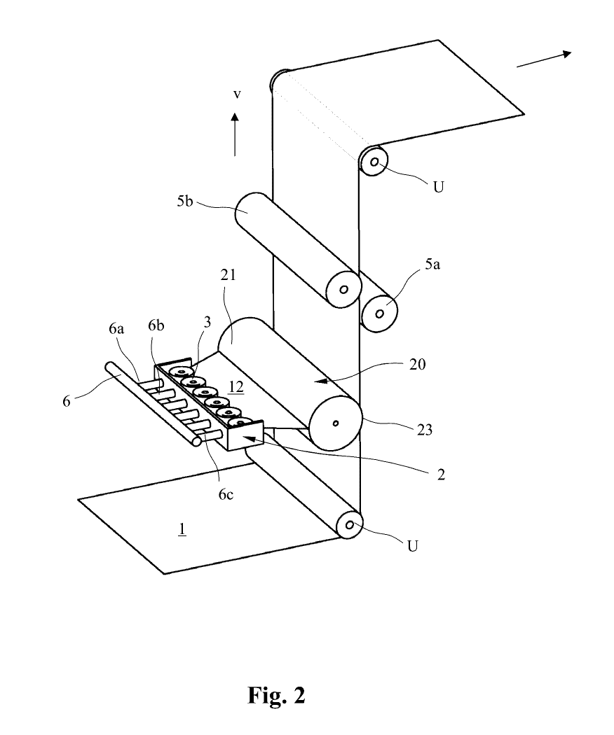

Downstream of the first drying unit 4 is an application device 10 for the application of an aqueous treatment solution to the surface of the strip 1 which is moved at the preset strip speed in the travel direction v of the strip. The application device 10 shown in detail in FIG. 2 comprises a rotary sprayer 2 and a roll coater 20. The rotary sprayer 2 has a plurality of spray rotors 3 which are disposed side by side at a distance from one another at a right angle to the travel direction of the strip. The spray rotors 3 are connected to a storage tank 9 via a central supply line 6 and branch lines 6a, 6b, 6c, etc., branching off said central supply line. The storage tank 9 holds the aqueous treatment solution which is to be applied to the surface of the steel strip. The aqueous treatment solution is preferably pumped by means of a pump 8 into the supply line 6 from where it is conducted into the branch lines 6a, 6b, 6c, with each branch line being connected to one of the spray rotors 3. To measure the amount of the aqueous treatment solution being pumped into the supply line 6, a flowmeter 11 is preferably provided.

The aqueous treatment solution is supplied to the spray rotors 3 of the rotary sprayer 2 via the supply line 6 and the branch lines disposed thereon. Each of the spray rotors 3 has a plate which is made to rotate by a drive. Because of the rotation of the plate of the spray rotors 3, the aqueous treatment solution supplied is moved by the centrifugal force outwardly to the rim of the plate. The rim of the plate is shaped in such a manner that the aqueous treatment solution in the form of minute droplets is propelled from the rim of the rotating plate. As a rule, the diameter of the droplets, as a function of the viscosity and the surface tension of the treatment solution used, measures between 30 and 70 micrometers. The droplets of the treatment solution being propelled from the rim of the plate are sprayed all around the rotating plate of the spray rotors 3.

The spray rotors 3 of the rotary sprayer 2 are disposed at a distance from the roll coater 20. The roll coater 20 comprises a driven rotating application roll 21 which is linked to a drive motor (not shown) which causes the application roll to rotate. The rotating spray rotors 3 of the rotary sprayer 2 spray the aqueous treatment solution onto the surface of the application roll 21 of the roll coater 20. To this end, the spray rotors 3 are disposed at a right angle to the travel direction of the strip and along the longitudinal axis of the application roll 21 in such a manner that the spray jets 12 of the adjacent spray rotors 3 overlap one another on the surface of the application roll 21, thereby ensuring a uniform application of the aqueous treatment solution across the entire length of the application roll 21.

The rotating application roll 21 applies the treatment solution adhering to its outer circumference to a surface of the strip 1 which is linearly moving at the strip speed along the travel direction v. To this end, in a transfer zone 23, the moving strip 1 is in contact with the surface of the rotating application roll 21 of the roll coater 20. As a result of the contact between the surface of the strip that faces the application roll 21 and the surface of the application roll 21, the treatment solution adhering to the surface of the application roll 21 is transferred to the surface of the strip. The direction of rotation and the speed of rotation are preferably adjusted to the travel direction v of the strip and to the strip speed so that, in the transfer zone 23, the direction of the tangential speed on the surface of the rotating application roll 21 corresponds to the travel direction v of the strip and the value of the tangential speed is at least substantially equivalent to the strip speed.

The amount of aqueous treatment solution supplied per unit of time to the spray rotors 3 is preferably adjusted to the strip speed v at which the steel strip 1 is moving. There is a linear correlation between the amount of the treatment solution supplied per unit of time to the spray rotors and the strip speed v. As a rule, the amount M the of treatment solution supplied per unit of time Δt to the spray rotors and relative to the width B of the steel strip 1 varies between M/Δt·B=0.4 and 5.5 L per minute and meter and preferably is in a range between M/Δt·B=1.0 and 3.5 L per minute and meter. At a typical strip speed of 200 to 700 m/min, the amount of the wet film of the treatment solution sprayed by means of the spray rotors 3 onto the surface of the steel strip 1 measures between 1 and 8 mL/m², preferably between 1 and 3 mL/m², and most preferably approximately 2 mL/m².

After application of the aqueous treatment solution in the form of a wet film to the surface or to each surface of the steel strip 1, the steel strip 1 can optionally be passed between driven rotating smoothing rollers 5a, 5b. The smoothing rollers 5 serve to homogeneously distribute the applied wet film of the aqueous solution. To this end, preferably a pair of smoothing rollers 5 is used, having two smoothing rollers 5 an and 5b that are offset with respect to each other. The offset arrangement of the smoothing rollers 5a, 5b is illustrated in FIGS. 1 and 2. As FIGS. 1 and 2 show, the smoothing rollers 5a, 5b are disposed with respect to each other in such a way that the line connecting the axes of rotation of the smoothing rollers, which run parallel to each other and parallel to the surface of the steel strip, in the cross section with the steel strip 1 passing between the two smoothing rollers encloses an angle of approximately 30° to 60°, in particular an angle of approximately 45°. In the process, the smoothing rollers do not exert substantial contact pressure onto the surface of the strip. This means that, if at all, only a very small portion of the treatment solution is squeezed off the surface of the strip. The pair of smoothing rollers 5 basically only serves to homogeneously distribute the wet film of the treatment solution across the entire surface of the strip. In this manner, a uniform application of a wet film of the treatment solution, with a homogeneous layer thickness across the entire surface of the strip, is ensured, and the accumulation of excess treatment solution that needs to be collected and transported to a recycling station is prevented.

After the steel strip 1 has passed through the smoothing rollers 5, it is transported to a second drying unit 7. The second drying unit 7 can be, for example, a drying furnace or an infrared or hot air dryer.

After the drying step, a uniform dry film coating of the treatment solution remains on the surface or on each surface of the steel strip 1, with the dry film weight after drying, as a rule, measuring between 1 and 50 mg/m² and preferably between 2 and 30 mg/m². The dry film weight of the treatment solution most preferably measures approximately 10 mg/m².

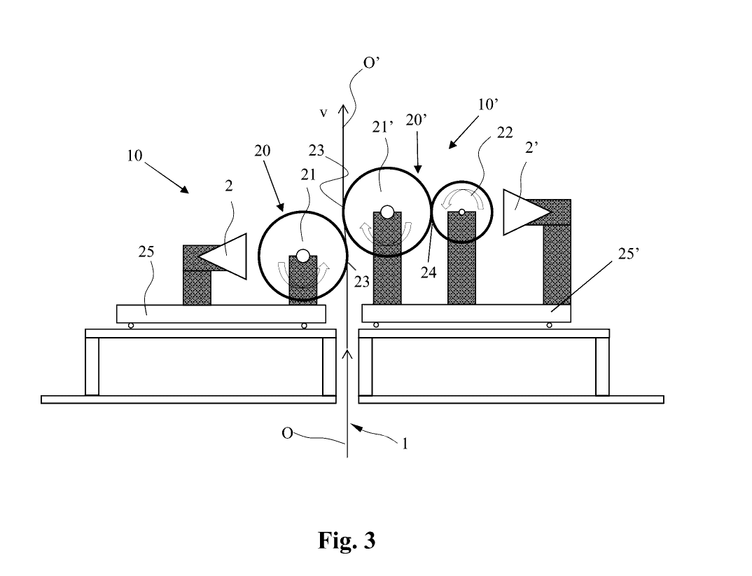

FIG. 3 shows a lateral view of another embodiment of a system for carrying out the method according to the present invention. This embodiment of the system for carrying out the method according to the present invention comprises a first application device 10 and a second application device 10′, with the first application device 10 being disposed on one side of the strip 1 to be treated and with the second application device 10′ being disposed on the other side of strip 1. The first application device 10 comprises a roll coater 20 having a single rotating roll, i.e., an application roll 21. As in the practical example of FIG. 2, the aqueous treatment solution is sprayed onto this single roll 21 by means of a rotary sprayer 2 disposed at a distance from roll 21.

The rotating application roll 21 which, in the practical example of FIG. 3, rotates in the counterclockwise direction applies the aqueous treatment solution to a surface of strip 1 which, at the strip speed, is moving linearly along the travel direction v of the strip. To this end, the moving strip 1, in a transfer zone 23, is in contact with the surface of the rotating application roll 21 of the roll coater 20. As a result of the contact between the surface of the application roll 21 and surface O of the strip which faces the application roll 21, the treatment solution adhering to the surface of the application roll 21 is transferred to surface O of the strip.

On the other side of strip 1, i.e., on the side facing the second surface O′ of the strip, a second application device 10′ is disposed. This second application device serves to apply the aqueous treatment solution to the second surface O′ of strip 1 and also comprises a roll coater 20′ as well as a rotary sprayer 2′. In contrast to the first application device 10, the roll coater 20′ of the second application device 10′ comprises two rotating rolls, i.e., a first rotating roll 21′ in the form of an application roll and a second rotating roll 22 in the form of a transfer roll. The application roll 21′ and the transfer roll 22 are driven to rotate, and the axes of the two rotating rolls 21′, 22 run parallel to each other. In a contact zone 24, the surfaces of the two rotating rolls 21′, 22 are in contact with each other. The two rotating rolls 21′ and 22 preferably rotate at the same tangential speed on their respective surfaces and in opposite directions to each other.

The rotary sprayer 2′ with a plurality of spray rotors 3 disposed side by side in the longitudinal direction of the transfer roll 22 is disposed at a distance from the transfer roll 22 and running parallel thereto. By means of the rotary sprayer 2′, the aqueous treatment solution is first sprayed onto the transfer roll 22 and, in the contact zone 24, transferred from said transfer roll to the application roll 21′. In a transfer zone 23, the surface of the rotating application roll 21′ is in contact with surface O′ of strip 1 so as to transfer the aqueous solution located on the surface of the application roll 21 to surface O′ of strip 1. The direction of rotation and the speed of rotation are adjusted to the travel direction of the strip and to the speed of the strip in such a manner that in the transfer zone 23, the direction of the tangential speed on the surface of the rotating application roll 21 is equivalent to the travel direction v of the strip and the value of the tangential speed coincides at least approximately with the strip speed.

Using the system shown in FIG. 3, both surfaces O, O′ of strip 1 can be coated with a wet film of the aqueous treatment solution. As in the practical example shown in FIG. 1, a device for homogeneously distributing or smoothing the wet film, in particular two smoothing rollers 5a, 5b which are offset with respect to each other, can follow the two application devices 10, 10′ downstream in the travel direction of the strip.

To make it possible to replace the rolls 21; 21′, 22 of the roll coaters 20; 20′ of the system shown in FIG. 3, it is recommended that the roll coaters 20, 20′ and the associated rotary sprayers 2, 2′ be disposed on sliding carriages 25, 25′. The carriages 25, 25′ are able to slide at a right angle to the travel direction v of the strip so that the first application device 10 as well as the second application device 10′ can be moved away from strip 1 when the rotating rolls of the roll coaters 20, 20′ need to be replaced. Via the sliding carriages 25, 25′, it is also possible to set the contact pressure of the application rolls 21, 21′ of the two roll coaters 20, 20′ on the surfaces O and O′, respectively, of strip 1. To this end, when carrying out the method, it is recommended that the carriages 25, 25′ can be locked in any position so as to be able to set a constant and consistent contact pressure of the application rolls 21, 21′ on strip 1 that is passing between the rolls.

The present invention is not limited to the embodiments that are illustrated in the drawings and that have been described in detail. Thus, if only one surface of strip 1 is to be coated with the aqueous treatment solution, it is possible to dispose an application device 10 or 10′ only on one side so as to coat the surface O or O′ facing the application device 10 or 10′, respectively, with the aqueous treatment solution. In addition, apart from the application roll 21 and an optionally provided transfer roll 22, it is also possible to dispose additional rotating rolls, the axes of which run parallel to the axis of the application roll 21, in the roll coater 20. If a plurality of such transfer rolls 22 are provided in the roll coater, it is recommended that a rotary sprayer 2 be dedicated to each transfer roll, by means of which rotary sprayer the aqueous treatment solution can be sprayed to the respective transfer roll. In this case, in a contact zone, each of the transfer rolls is in contact with the surface of the application roll 21 so as to transfer the aqueous treatment solution from the respective transfer roll 22 to the application roll 21.

The application device 10 according to the present invention can essentially be used to apply any aqueous treatment solutions to one or both surfaces of moving strips and is especially suitable for use for the treatment of steel strips. The steel strips may be coated with an anti-corrosion metal coating, for example, a tin coating. The aqueous treatment solutions can, for example, be passivating solutions, such as are known, for example, for passivating tinned sheet iron or black sheet iron. Suitable treatment solutions are listed, for example, in DE 10 2013 107 505 A1. If necessary, prior to applying the aqueous treatment solution, the strip can be pretreated, for example, by means of anodic oxidation or cleaning and/or drying the surface(s) of the strip.

What is claimed is:

1. A method for application of an aqueous treatment solution to the surface of a strip moving at a preset strip speed in a travel direction of the strip, comprising the following steps:
spraying the aqueous treatment solution onto at least one rotating roll of a roll coater with a rotary sprayer having a plurality of spray rotors disposed side by side in the longitudinal direction of the roll, to which the aqueous treatment solution is supplied and which are made to rotate by a spray rotor drive so that the treatment solution, driven by the centrifugal force, is sprayed in the form of a spray jet onto the surface of the roll,
applying the aqueous treatment solution to at least one surface of the strip by moving the strip at the preset strip speed past a rotating application roll of the roll coater, with the application roll transferring the aqueous treatment solution in the form of a wet film onto the surface of the strip.

2. The method as in claim 1, wherein the treatment solution is sprayed with the rotary sprayer onto the application roll.

3. The method as in claim 1, wherein the treatment solution is sprayed with the rotary sprayer onto a transfer roll, the axis of which runs parallel to the axis of the application roll and the surface of which is in contact with the surface of the application roll.

4. The method as in claim 3, wherein the transfer roll rotates in the opposite direction to the application roll, preferably at the same or at least approximately the same angular speed as the application roll.

5. The method as in claim 1, wherein, in a transfer zone, the surface of the application roll is in contact with the surface of the strip, with the direction of the tangential speed of the surface of the rotating application roll in the transfer zone corresponding to the travel direction of the strip.

6. The method as in claim 1, wherein, prior to the application of the treatment solution, the steel strip is dried with a gas stream preferably being blown in the form of a laminar hot air stream with an air knife onto the surface of the moving strip.

7. The method as in claim 1, wherein homogeneously distributing the wet film of the aqueous treatment solution, which was transferred onto the surface of the strip, with driven smoothing rollers and by subsequently drying the applied wet film of the treatment solution so as to produce a dry film coating of the treatment solution on the surface of the strip.

8. The method as in claim 1, wherein the amount of the treatment solution supplied per unit of time to the spray rotors is adjusted to the travel speed of the strip.

9. The method as in claim 1, wherein the strip speed is in a range between 200 and 750 m/min and the value of the tangential speed of the application roll corresponds at least approximately to the strip speed.

10. An application device for the application of an aqueous treatment solution to the surface of a strip moving at a preset strip speed into travel direction of the strip, with
a roll coater comprising at least one first rotating roll for the application of the aqueous treatment solution to at least one surface of the strip and optionally one or more additional rotating rolls, the axes of which run parallel to the axis of the first rotation roll and the surface of which is in contact with the surface of the first roll,
a rotary sprayer having a plurality of spray rotors, to which rotary sprayer the aqueous treatment solution is supplied and which is disposed at a distance from one of the rolls of the roll coater, with the spray rotors being disposed side by side along the axis of this roll and being made to rotate by a spray rotor drive so that the treatment solution, driven by the centrifugal force, is sprayed in the form of a spray jet onto the surface of this roll.

11. The application device as in claim 10, wherein the roll, onto which the treatment solution is sprayed with the rotary sprayer, is the first roll or a transfer roll, the axis of which runs parallel to the axis of the first roll and the surface of which is in contact with the surface of the first roll.

12. The application device as in claim 10, wherein the rotary sprayer serving to supply the aqueous treatment solution is linked to a supply line which comprises a supply line which is connected to the spray rotors of the rotary sprayer, on the one hand, and to a storage tank for the treatment solution, on the other hand.

13. A system for carrying out the method as in claim 1, comprising:
a transporting unit for transporting the strip at a preset strip speed in a travel direction of the strip;
an application device, with the first roll of the roll coater serving as the application roll which, in a transfer zone, is in contact with a surface of the strip so as to apply the aqueous treatment solution to this surface of the strip with the axis of the first strip running parallel to the surface of the strip and being perpendicular to the travel direction of the strip.

14. The system as in claim 13, wherein the first roll of the roll coater which serves as the application roll is linked to an application roll drive which causes the first roll to rotate and/or that the first roll which serves as the application roll is in contact with a transfer roll which is linked to a drive which causes the transfer roll to rotate.

15. The system as in claim 13, further comprising
a first drying unit for drying the strip,
a pair of driven smoothing rollers which, in the travel direction of the strip, are disposed downstream of the roll coater and which serve to homogeneously the applied wet film of the treatment solution onto the surface of the strip,
and a second drying unit for drying the wet film of the treatment solution that had been applied to the surface of the strip.
